(19) United States
(12) Patent Application Publication
(10) Pub. No.: US 2002/0035932 A1
(43) Pub. Date: Mar. 28, 2002

(54) Mobile processing apparatus for extracting juice from citrus fruit and associated methods

(76) Inventor: Burgess Chambers, Winter Park, FL (US)

Correspondence Address: Enrique G Estevez, Allen Dyer Doppelt Milbrath & Gilchrist PA, 255 South Orange Avenue Suite 1401, P O Box 3791, Orlando, FL, 32802-3791, US

(21) Appl. No.: 09/573,578

(22) Filed: May 18, 2000

(51) Int. Cl. A23L 1/00; A23N 1/00; A47J 43/14

(52) U.S. Cl. 99/495; 99/501; 99/506

(57) ABSTRACT

A mobile apparatus and method for processing citrus fruit into juice on-site at a grove comprises a hopper, at least one fruit washer, a citrus peel oil separator, a dryer for drying the fruit, a juice extractor for extracting juice from the fruit, a pulp separator for separating pulp from the extracted juice, and a refrigerated juice tank for holding the juice. The mobile apparatus is positioned on a support having a plurality of wheels. A source of hot water may be connected to the fruit washer. A controller is operably connected for controlling the apparatus. A method comprises positioning a mobile citrus fruit processing apparatus on-site at the citrus grove, the apparatus comprising a fruit washer, and a juice extractor; processing the fruit in the apparatus for extracting juice; and refrigerating the extracted juice.

### FIELD OF THE INVENTION

The present invention relates to the field of extracting juice from citrus fruit and, more particularly, to a mobile apparatus for extracting juice from citrus fruit on-site at a grove, and associated methods.

### BACKGROUND OF THE INVENTION

Citrus fruit is commercially grown in large groves which may be spread out over a wide geographic area. The fruit must be harvested by hand when mature and transported by truck to a processing plant where the fruit is stored until the juice is extracted, processed, and packaged for sale. Other byproducts obtained during processing also have commercial value, for example, citrus oils used for making a variety of products, including organic cleaners, fragrance, flavorings, cattle feed, and others.

Processing plants for citrus fruit are usually sited within a citrus producing area for serving widely scattered grove operations. Accordingly, there must necessarily be transportation of fruit from the groves to a more or less central processing plant. A fixed citrus processing plant has high fixed and variable operating costs. Accordingly, such plants are generally inefficient unless they operate at near or above capacity. Growers experience the impact of these high costs as lower returns on their crops. The price of the citrus increases along the progression from grove, to processing plant, to packer, to retailer. Consequently, it is the citrus grower who by being at the bottom of the distribution chain obtains the lowest price per gallon of citrus juice. In today's market in the U.S. the citrus grower receives about seventy cents per gallon of citrus juice. The estimated cost of transporting the fruit from the grove to the processing plant is from about seven to about ten cents per gallon of finished juice. As transportation and processing costs are added to the product, however, the U.S. consumer today pays on the average of about five dollars per gallon for pasteurized juice. The grower not only receives a low return on his crop, but is also totally dependent on processors for moving his crop to the juice market.

In addition, just as with any other industrial facility, a citrus processing plant must be taken off-line at planned intervals for routine maintenance of the equipment. When one or more plants are inoperative, a glut of fresh fruit is created as the available processing capacity is exceeded by the supply of fruit. Under these conditions, it is likely that excess fruit will begin to spoil. This situation further drives down the price paid to the grower for fresh fruit, since the fruit will deteriorate unless timely processed. Even though there is an excess of fruit, the limited processing capacity continues to drive the market price of citrus juice. Consequently, the consumer does not benefit from a drop in fresh juice prices, even though fresh fruit is available in excess.

Furthermore, present practice requires that the citrus fruit withstand fairly severe handling, transportation to a processing facility, and at least several days' storage before the juice is extracted. For example, a field worker picks the fruit and deposits it into a sack usually worn around the shoulder. When the sack is full, the worker will dump the sackload into one of many tubs placed throughout the grove for the purpose. When the tub is filled, it is picked up by another worker with a machine known in the trade as a “goat”. The goat carries the filled tub to an open trailer, into which the fruit is then dumped. The trailer is filled with fruit as harvesting progresses, and then remains on-site until hitched to a truck for transporting the fruit to a processing plant. In practice, the fruit will be in transit to a processing plant for about two to three days, during which time it remains in the open trailer. Upon arrival at the processing plant, the fruit is dumped into a hopper to await processing. Those skilled in the art know that this process causes fruit arriving at the processing plant to be bruised and usually very dirty.

### SUMMARY OF THE INVENTION

With the foregoing in mind, the present invention advantageously provides a mobile apparatus for processing citrus fruit into juice on-site at a grove. An object of the invention is to reduce the cost of transportation fruit and the cost of processing the fruit into juice. In addition, the citrus grower may directly put this invention to use and may reduce or eliminate dependence on regional processing plants by having the ability of extracting fresh citrus juice on-site at the grove.

The mobile processing apparatus provides the grower with the ability of deciding to which packaging plant juice will be sent, in effect creating a more decentralized market. For example, any dairy plant has the capability of pasteurizing and packaging fresh citrus juice, so that there are many potential packagers available in any given region. Rather than sending all the fresh fruit to a processor who then decides where the juice will be packaged and marketed, the grower will be able to choose a packager serving any desired market area. The mobile processing apparatus of the present invention will substantially enable the grower to bypass the fixed processing plant, a costly intermediary, and to assume more complete responsibility for marketing his own product.

Additionally, the grower may also use the mobile processing plant according to the present invention for making up some or all the lost processing capacity when a regional plant is shut down for maintenance. The fresh citrus juice may then be taken directly to a packager for preparation for retail sale, bypassing the standard processing plant. When harvests exceed projections, the mobile processing plant may be used to meet the need for additional processing capability. The mobile processing plant also has the ability to follow a harvest season in growing regions as the fruit matures.

The apparatus and method of the invention for extracting citrus juice on-site at the grove also reduces the amount of handling and storage time to which the fruit is subjected. As noted above, fruit is normally hand picked, dumped into a tub, a filled tub is then dumped into a trailer which may sit for a day or two while fruit is getting dirtier and awaiting transportation to a processor, the fruit is then dumped into a hopper at the processing plant. In the present invention, the fruit is taken directly from the collection tub to the mobile processing apparatus. The fruit, then, is less bruised and less contaminated with dirt. In the present method, the fruit may also be expected to carry a lower microbial load, since it goes substantially directly from the tree to the processing apparatus and does not sit in a trailer for any period of time.

In one embodiment, the mobile citrus fruit processing apparatus comprises a hopper for receiving fruit for processing. At least one fruit washer is positioned downstream from the hopper for washing the fruit. An oil separator is connected to at least one fruit washer for removing citrus peel oil from spent wash water. A dryer downstream from the fruit washer is employed for drying the fruit. A sizer downstream from the dryer is positioned for sorting the fruit according to size, The apparatus may also comprise a plurality of juice extractors. A pulp separator downstream from the juice extractor separates pulp from the extracted juice. A refrigerated juice tank downstream holds the juice chilled to substantially prevent spoilage.

The apparatus may further comprise a power source for providing processing power. The power source may advantageously comprise a diesel engine. A hot water source serves for providing hot water for the fruit washer. Those skilled in the art will know that a diesel engine may be provided with a heat exchanger useful for heating water, and could serve as the source of hot water for the fruit washer. A controller is operably connected for controlling processing. The apparatus is positioned on a support having a plurality of wheels to thereby provide mobility. The skilled will know that a truck may be used for providing propulsion for the mobile apparatus. Method aspects of the invention are also described for extracting juice from citrus fruit on-site at a grove.

Method aspects of the invention include positioning on-site at the citrus grove a mobile citrus fruit processing apparatus comprising a juice extractor; extracting juice from the citrus fruit by processing the fruit in the mobile apparatus; and refrigerating the extracted juice. Additionally, another embodiment of the method for extracting juice on-site at a citrus grove includes harvesting mature citrus fruit until substantially all mature fruit has been harvested from the grove; extracting juice from the harvested fruit on-site; and refrigerating the extracted juice substantially immediately after extracting. In an embodiment of the method, extracting is accomplished substantially while harvesting, so that juice is extracted from fruit shortly after fruit is harvested. Extracting may, thus, be accomplished substantially within about four hours from harvesting.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a flow diagram schematically illustrating the components of the mobile apparatus according to an embodiment of the present invention;

FIG. 2 shows a plan view of an embodiment of the mobile apparatus; and

FIG. 3 is a flow diagram showing the steps in a method aspect of the apparatus of FIG. 1.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art. Like numbers refer to like elements throughout, and prime notation when used indicates similar elements in alternative embodiments.

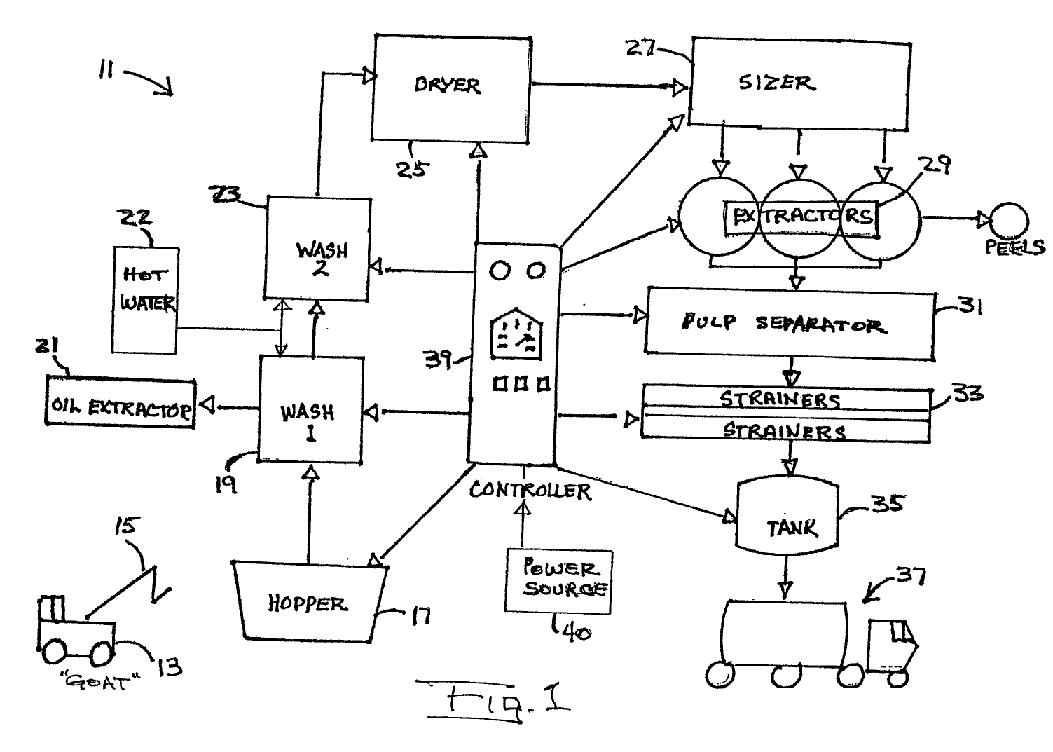

FIG. 1 illustrates a mobile citrus fruit processing apparatus 11 and method for extracting juice from citrus fruit on-site at a grove on a commercial scale. The various components of the present invention are as known in the art, but are adapted for positioning on a mobile support as described herein. The mobile apparatus is made mobile preferably by being positioned on a support having a plurality of wheels, for example a semitrailer for towing by a truck tractor.

In a preferred embodiment, as shown in FIG. 1, the mobile citrus fruit processing apparatus 11 comprises a hopper 17 for receiving fruit delivered for processing. The “goat”, described above as a mechanical device 13 for picking up filled fruit bins and delivering them to the processing apparatus is shown as including a pickup arm 15. The fruit proceeds downstream from the hopper 17 to a fruit washer 19 for washing. The fruit washer 19 employs water, preferably provided from a hot water source 22 as known in the art, and includes brush rollers to aid in washing and to help remove citrus peel oil from the skin of the fruit. The apparatus may also include more than one fruit washer 19, 23, as shown in FIG. 1.

In another embodiment, spent wash water containing citrus peel oil passes through an oil separator 21 for separating the oils from the water. The skilled artisan will know that the fruit washer 19, 23 may comprise a single, extended device having a plurality of fruit washers, brush rollers, and a fruit dryer positioned downstream therefrom. A dryer 25 may be positioned downstream from fruit washers 19 and 23 for drying the fruit as it progresses through the processing line. A juice extractor 29 downstream from the dryer 25 extracts juice from the fruit. In yet another preferred embodiment, a pulp separator 31 downstream from the juice extractor is positioned for separating pulp from the extracted juice. The pulp separator preferably includes at least one pulp strainer 33 for separating the pulp from the juice. A juice tank 35 is connected downstream from the pulp separator for holding the extracted juice, the tank being a refrigerated tank in a preferred embodiment of the invention.

Those skilled in the art will understand that there may be several other components of such a mobile citrus fruit processing apparatus. For example, it should be recognized that the apparatus may comprise a power source 40 connected thereto for providing power for processing. In addition, a controller 39 is preferably connected to the apparatus for controlling processing. In a further embodiment, a sizer 27 is positioned downstream from the dryer 25 for sorting the fruit by size. The apparatus 11 may, therefore, include a plurality of extractors for extracting juice from fruit according to fruit size. As known in the art, an extractor comprises a reamer which penetrates and reams out the fruit for extracting the juice.

The skilled artisan will also know that fresh citrus juice will require refrigeration if untreated for removing or retarding its naturally occurring microbial contaminants. Accordingly, in an embodiment of the invention the juice tank 35 comprises refrigeration. The juice tank may be part of the mobile apparatus or may be separate therefrom, either permanently located at the grove, or part of a truck and trailer combination 37. Such a refrigerated tanker truck 37 could be connected to the mobile apparatus 11 for directly receiving the freshly extracted juice.

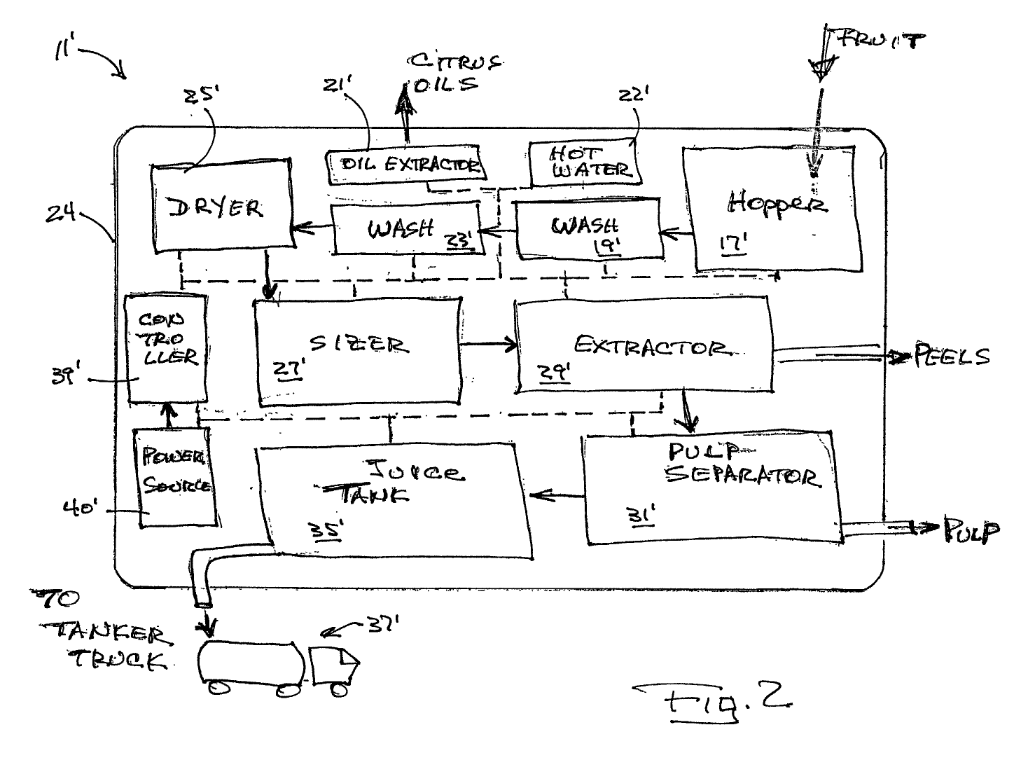

FIG. 2 shows a plan view illustrating one possible embodiment of the apparatus positioned on a mobile support, such as a semitrailer. The components of the mobile apparatus are as discussed above. Preferably, the flow of the operation would be organized for fresh fruit to be delivered into the apparatus on one side of the mobile support platform 24, and extracted juice to be offloaded into a tanker truck 37′ at an opposite side of the apparatus, so as to prevent interference between these operations. The semitrailer support platform 24 may advantageously be designed so as to have openable side panels to provide access to the apparatus for operation and maintenance, as well as ventilation for dissipating heat expected to be given off by the operation. The skilled artisan will recognize that components of the mobile apparatus may also be interconnected with each other. For example, the power source may advantageously be a diesel engine having a heat exchanger whereby water could be heated for use in the fruit washer.

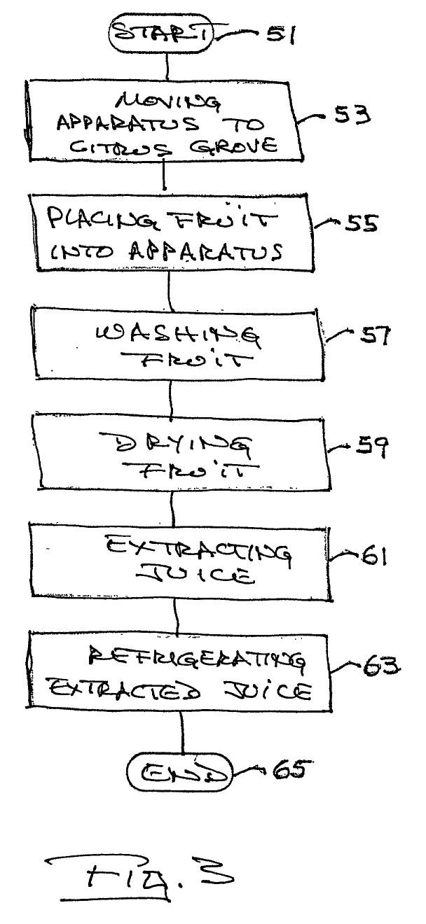

Method aspects of the present invention are shown in FIG. 3 and include a method of processing citrus fruit on-site at a citrus grove for extracting juice. From the start (Block 51) the method comprises positioning (Block 53) a mobile citrus fruit processing apparatus on-site at the citrus grove, the apparatus comprising a fruit washer, and a juice extractor; processing the fruit in the apparatus for extracting juice (Block 55); and refrigerating the extracted juice (Block 57), whereafter the method stops at Block 59.

In an alternate embodiment of the method, the mobile citrus fruit processing apparatus comprises a support having a plurality of wheels for providing mobility. The mobile support preferably comprises a semitrailer, and refrigerating comprises a mobile refrigerated tank. Refrigerating may, therefore, comprise a refrigerated tank truck, or alternatively refrigerating comprises holding the extracted juice in a refrigerated tank. A further step in a preferred method includes separating pulp from the extracted juice in a separator.

Yet another method aspect of the invention includes harvesting substantially all mature citrus fruit from the grove, extracting juice from the harvested fruit on-site, and substantially immediately refrigerating the extracted juice. The method includes extracting substantially while harvesting, so that juice is extracted from fruit shortly after fruit is harvested to thereby obtain very fresh juice. Extracting may be accomplished substantially within about four hours from harvesting.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That which is claimed:

1. A citrus fruit processing apparatus positioned on a mobile support for extracting juice from citrus fruit on-site at a grove, said apparatus comprising:
a fruit washer having water for washing the fruit;
a juice extractor downstream from said fruit washer for extracting juice from the fruit;
a pulp separator downstream from said juice extractor for separating pulp from the extracted juice; and
a juice tank downstream from said pulp separator for holding the extracted juice.

2. The apparatus of claim 1, wherein said mobile support comprises a plurality of wheels to thereby provide mobility.

3. The apparatus of claim 1, further comprising a power source connected for providing power for processing.

4. The apparatus of claim 1, further comprising a controller connected for controlling processing.

5. The apparatus of claim 1, further comprising a source of hot water connected to said fruit washer.

6. The apparatus of claim 1, further comprising an oil separator connected to said fruit washer for separating citrus peel oil from spent wash water.

7. The apparatus of claim 1, further comprising a sizer positioned downstream from said dryer for sizing the fruit.

8. The apparatus of claim 1, wherein said extractor comprises a reamer for reaming the fruit to thereby extract juice.

9. The apparatus of claim 1, wherein said juice tank comprises refrigeration.

10. The apparatus of claim 1, further comprising a dryer downstream from said fruit washer for drying the fruit.

11. The apparatus of claim 1, wherein said pulp separator comprises at least one pulp strainer for straining citrus pulp from the extracted juice.

12. A mobile citrus fruit processing apparatus for extracting juice from citrus fruit, said mobile apparatus comprising:
a fruit washer having water for washing the fruit;
a juice extractor downstream from said fruit washer for extracting juice from the fruit; and
a mobile support whereon said apparatus is positioned.

13. The apparatus of claim 12, further comprising a juice tank positioned downstream from said pulp separator for holding the extracted juice.

14. The apparatus of claim 12, wherein said juice tank comprises refrigeration.

15. The apparatus of claim 12, further comprising a power source connected for providing power for processing.

16. The apparatus of claim 12, further comprising a controller connected for controlling processing.

17. The apparatus of claim 12, further comprising a source of hot water connected to said fruit washer.

18. The apparatus of claim 12, further comprising an oil separator connected to said fruit washer for separating citrus peel oil from spent wash water.

19. The apparatus of claim 12, further comprising a sizer positioned for sizing the fruit.

20. The apparatus of claim 12, wherein said extractor comprises a reamer for reaming the fruit to thereby extract juice.

21. The apparatus of claim 12, further comprising a dryer positioned downstream from said fruit washer for drying the fruit.

22. The apparatus of claim 12, wherein said fruit washer comprises brush rollers for aiding in extracting citrus peel oil from the fruit.

23. The apparatus of claim 12, further including a pulp separator downstream from said juice extractor for separating pulp from the extracted juice.

24. The apparatus of claim 12, wherein said mobile support comprises a plurality of wheels.

25. A method of processing harvested citrus fruit on-site at a citrus grove for extracting juice, the method comprising:
positioning on-site at the citrus grove a mobile citrus fruit processing apparatus comprising a juice extractor;
extracting juice from the citrus fruit by processing the fruit in the mobile apparatus; and
refrigerating the extracted juice.

26. The method of claim 25, wherein the mobile citrus fruit processing apparatus comprises a support having a plurality of wheels for providing mobility.

27. The method of claim 25, wherein the mobile citrus fruit processing apparatus comprises a semitrailer.

28. The method of claim 25, wherein refrigerating comprises a mobile refrigerated tank.

29. The method of claim 25, further comprising separating pulp from the extracted juice.

30. A method of processing citrus fruit for extracting juice on-site at a citrus grove, the method comprising:
harvesting mature citrus fruit until substantially all mature fruit has been harvested from the grove;
extracting juice from the harvested fruit on-site; and
refrigerating the extracted juice substantially immediately after extracting.

31. The method of claim 30 further comprising separating pulp from the extracted juice.

32. The method of claim 30 wherein extracting is performed by an apparatus positioned on a mobile support comprising a plurality of wheels.

33. The method of claim 30 wherein extracting is accomplished substantially while harvesting, so that juice is extracted from fruit shortly after fruit is harvested.

34. The method of claim 30 wherein extracting is accomplished substantially within about four hours from harvesting.
